(19) United States
(12) Patent Application Publication
(10) Pub. No.: US 2007/0031154 A1
(43) Pub. Date: Feb. 8, 2007

(54) Measurement system having modulated laser source

(76) Inventors: Gregory D. VanWiggeren, San Jose, CA (US); Douglas M. Baney, Los Altos, CA (US); Scott W. Corzine, Sunnyvale, CA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/197,873

(22) Filed: Aug. 5, 2005

(51) Int. Cl. H04B 10/00

(52) U.S. Cl. 398/140

(57) ABSTRACT

A measurement system has a modulated laser source that illuminates a target within the measurement system. The modulated laser source has a first coherence length in an unmodulated state, and a second coherence length in a modulated state that is shorter than the first coherence length. The measurement system includes a detector that receives a deflected signal from the target and provides a detected signal having a signal component and a drift component, wherein the drift component is lower in the modulated state than in the unmodulated state of the modulated laser source.

### BACKGROUND OF THE INVENTION

A conventional surface plasmon resonance (SPR) measurement system typically includes one or more light emitting diodes (LEDs) that illuminate a target. LEDs have a coherence length that is sufficiently long to enable an SPR measurement system to detect small shifts in SPR resonances, which can provide for high accuracy and high sensitivity for the SPR measurement system. LEDs also have the advantage of being inexpensive. However, light that is provided by an LED is not highly directional and typically has low power. These properties of the LED can reduce the amount of light that is incident on the target and can reduce signal-to-noise (SNR) ratio, which can correspondingly reduce accuracy and sensitivity of the SPR measurement system.

A super-luminescent light emitting diode (SLED) has many of the performance benefits of a conventional LED, but the SLED has higher power and provides more directional light than a conventional LED. However, SLEDs are presently substantially more expensive than conventional LEDs.

Lasers can provide high power light that is highly directional, at a cost that is typically lower than that of a SLED. A conventional laser also has a coherence length that is sufficiently long to provide the SPR measurement system with enough measurement resolution to detect small shifts in SPR resonances. However, the coherence length of a conventional laser can be long enough to produce interference effects that reduce the accuracy and measurement repeatability of an SPR measurement system.

Accordingly, there is need for a light source that has the low cost, high power and high directionality features of a conventional laser, without the interference effects that result from the long coherence length of the conventional laser.

### BRIEF DESCRIPTION OF THE DRAWINGS

FIG. 1 shows a measurement system having a modulated laser source according to embodiments of the present invention.

FIGS. 2A-2C show examples of modulated laser sources included in the measurement system according to embodiments of the present invention.

FIGS. 3A-3B show examples of optical signals provided by a modulated laser source in an unmodulated state and a modulated state.

FIG. 4 shows a flow diagram of a method for establishing attributes of a modulation signal provided to the modulated laser source included in the measurement system according to embodiments of the present invention.

FIGS. 5A-5C show examples of detected signals provided by the measurement system according to embodiments of the present invention.

FIGS. 6A-6B show examples of optical signals provided by the modulated laser source included in the measurement system according to embodiments of the present invention.

### DETAILED DESCRIPTION

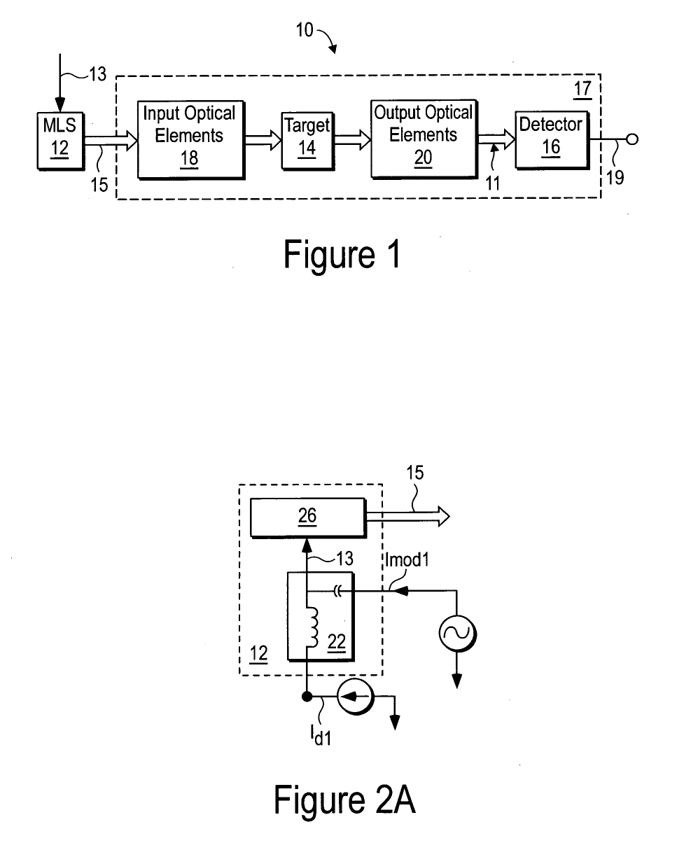

FIG. 1 shows a measurement system 10, according to embodiments of the present invention, that includes a modulated laser source 12, a target 14 and a detector 16. For the purpose of illustration, the measurement system 10 is shown including the target 14, detector 16 and associated input optical elements 18 and output optical elements 20 that are typical of a surface plasmon resonance (SPR) measurement system 17. In the example shown in FIG. 1, the target 14 includes an SPR sensor, and the input optical elements 18, output optical elements 20 and detector 16 are configured to detect shifts in refractive indices of samples within the SPR sensor. The SPR sensor, the input optical elements 18, the output optical elements 20, and the detector 16 of an SPR measurement system 17 are disclosed in a variety of references, including Optical Biosensors: Present and Future, Edited by F. S. Ligler and C. A. Rowe Taitt, Elsevier Science B. V., pages 207-247.

According to an alternative embodiment of the present invention, the measurement system 10 includes the components of a reflectometric interference spectroscopy (RIfS) measurement system, wherein the target 14 includes a RIfS sensor. An example of a RIfS measurement system and a RIfS sensor is disclosed in Quantification of Quaternary Mixtures of Alcohols: a comparison of reflectometric interference spectroscopy and surface plasmon resonance spectroscopy, by Maura Kasper, Stefan Busche, Frank Dieterle, Georg Beige and Gunter Gauglitz, Institute of Physics Publishing, Measurement Science and Technology, 15, (2004), pages 540-548.

According to alternative embodiments of the present invention, the measurement system 10 includes the components of a coupled plasmon-waveguide resonance (CPWR) measurement system, wherein the target 14 includes a CPWR sensor. An example of a CPWR measurement system and a CPWR sensor is disclosed in Optical Anisotropy in Lipid Bilayer Membranes; Coupled Plasmon-Waveguide Resonance Measurements of Molecular Orientation, Polarizability, and Shape, by Zdzislaw Salamon and Gordon Tollin, Biophysical Journal, Volume 80, March 2001, pages 1557-1567.

The SPR measurement system 17 (shown in FIG. 1), the RIfS measurement system, and the CPWR measurement system are examples of the measurement system 10 that are suitable for providing detection and quantification of environmentally relevant compounds or for label-free analysis of bio-molecular interactions. While these example are provided for the purpose of illustrating embodiments of the present invention, the measurement system 10 can be any optical system or configuration wherein the modulated laser source 12 illuminates the target 14, and the target 14 provides a deflected signal 11, such as a reflected, refracted or transmitted signal, to the detector 16 in response to the illumination by the modulated laser source 12.

The modulated laser source 12 in the measurement system 10, according to embodiments of the present invention, typically includes a laser diode, a solid-state laser, a gas laser, a semiconductor laser with an external cavity, or any other type of laser with sufficiently high power and sufficiently directional light to illuminate the target 14 and provide a suitable signal-to-noise ratio (SNR) for the measurement system 10. In one example, the modulated laser source 12 includes a Samsung model DL7140-201S laser diode that provides 80 mW of highly directional light that can be amplitude modulated to provide the modulated laser source 12.

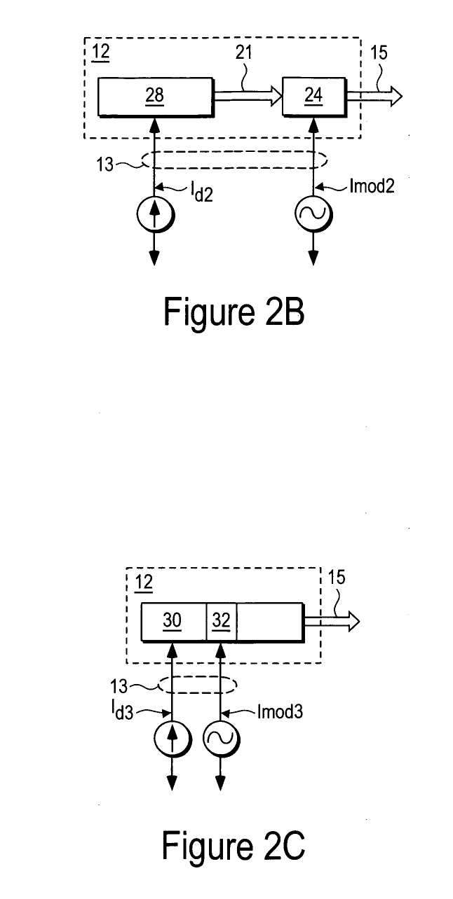

A modulation signal 13 is applied to the modulated laser source 12 to provide an optical signal 15. The characteristics of the modulation signal 13 typically depend on the type of laser that is included in the modulated laser source 12. In an example shown in FIG. 2A, the modulated laser source 12 includes a bias tee 22 or other circuit or system that enables a drive current I_{d1}, such as a DC drive current, and a modulation current I_{mod1}, such as an AC current, to be applied to a laser 26 within the modulated laser source 12. The modulation signal I_{mod1} amplitude modulates the laser 26, enabling the modulated laser source 12 to provide the optical signal 15 within the measurement system 10. In this example, the modulation signal 13 applied to the modulated laser source 12 includes the drive current I_{d1} and a superimposed modulation current I_{mod1}.

In an example shown in FIG. 2B, light 21 provided by a laser 28 within the modulated laser source 12 is modulated via a modulation current I_{mod2} that is applied to a modulator 24 that is external to the laser 28. The optical modulator 24 is typically a Mach-Zehnder interferometer-based modulator that is fabricated using LiNBO₃, or GaAs as an electrooptic material. However, the modulator 24 is alternatively any suitable electrooptic device, or other type of device, element or system that provides for amplitude modulation of the light 21 to provide the optical signal 15 within the measurement system 10. In this example, the modulation signal 13 applied to the modulated laser source 12 includes a drive current I_{d2} and a separate modulation current I_{mod2}.

In an example shown in FIG. 2C, the modulated laser source 12 includes a laser 30 that is modulated via a modulation signal I_{mod3} that is applied to a modulator 32 that is internal to the laser 30. The modulator 32 in this example is typically an acoustooptic deflector, or an electrooptic switch that provides for Q-switching of the laser 30 to provide the optical signal 15 within the measurement system 10. In this example, the modulation signal 13 applied to the modulated laser source 12 includes a drive current I_{d3} and a separate modulation current I_{mod3}.

In alternative examples, the modulation signal 13 provides for mode-locking, frequency-chirping, or a gain-switching of the laser that is included in the modulated laser source 12. Mode-locked lasers, and examples of the corresponding optical signals 15 provided by the mode-locked lasers, are disclosed in references, such as Optical Electronics, Fourth Edition, by Amnon Yariv, Saunders College Publishing, ISBN 0-03-047444-2, pages 190-200. Frequency-chirped lasers, gain-switched lasers, and examples of corresponding optical signals 15 provided by the lasers, are disclosed in references, such as Long-Wavelength Semiconductor Lasers, G. P. Agrawal and N. K. Dutta, Van Nostrand Reinhold Company, ISBN 0-442-20995-9, pages 263-281. In an alternative example, the modulated laser source 12 includes a passive mode-locked laser. The modulated laser source 12 can also include any other type of laser that can be amplitude and/or frequency modulated via the modulation signal 13 to reduce coherence length of the laser.

The modulated laser source 12 has an unmodulated state wherein the modulated laser source 12 is not modulated. In the unmodulated state, the optical signal that is provided has a first coherence length. The modulated laser source 12 has a modulated state wherein the modulation signal 13 is applied to the modulated laser source 12 to provide the optical signal 15. In the modulated state, the modulated laser source 12 has a second coherence length that is shorter than the first coherence length. In one example, the modulated laser source 12 includes a laser diode that has a coherence length of greater than ten meters in the unmodulated state, and a coherence length of less than two centimeters in the modulated state. The reduction in coherence length between the modulated state and the unmodulated state in this example is achieved via the modulation signal 13 applied to the modulated laser source 12 that includes a sinusoidal modulation current I_{mod1} with a peak-to-peak amplitude of 30 mA at a frequency of 690 MHz, superimposed on a drive signal I_{d1} of 40 mA DC.

Coherence length is typically defined as in Fiber Optic Test and Measurement, edited by Dennis Derickson, Prentice Hall PTR, ISBN 0-13-534330-5, pages 172-173, as the product of the coherence time of a laser source and the velocity of light, where the coherence time is defined as 1/(πΔν), where Δν is the full-width half-maximum (FWHM) of the optical signal 15. The coherence length can also have alternative definitions that depend on the characteristics of the modulation signal 13 and the resulting optical signal 15.

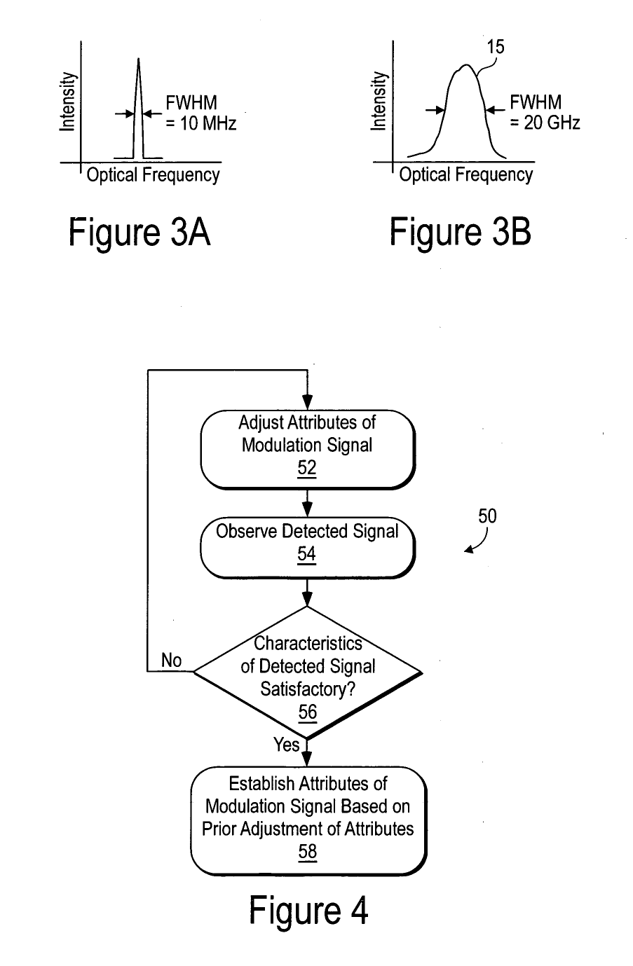

FIGS. 3A-3B show examples of optical signals provided by the modulated laser source 12 in the unmodulated state (FIG. 3A) and a modulated state (FIG. 3B), when the modulated laser source 12 includes the Samsung model DL7140-201S laser diode. In the unmodulated state, the resulting optical signal in FIG. 3A has a FWHM of 10 MHz. In the modulated state, the resulting optical signal 15 in FIG. 3B has a FWHM of 20 GHz, indicating that the coherence length of the modulated laser source 12 is substantially reduced in the modulated state. It is appreciated that the reduction in coherence length in the modulated state relative to the unmodulated state can be achieved with a panoply of modulation signals 13 that have a broad range of amplitudes, waveform shapes, frequencies or other attributes sufficient to achieve a corresponding reduction of coherence lengths.

According to one embodiment of the present invention, attributes of the modulation signal 13 are established according to a method 50 shown in FIG. 4. The method 50 includes adjusting designated attributes of the modulation signal 13 such as one or more of the amplitude, waveform shape, and frequency of the modulation signal 13 (step 52). Step 54 of the method 50 includes observing a detected signal 19 provided by the measurement system 10 in response to the adjustment of the designated attributes of the modulation signal 13. In step 56, if the characteristics of the detected signal 19 are satisfactory, according to a predesignated criterion, either steps 52 and 54 of the method 50 are repeated to achieve different characteristics, or the attributes of modulation signal 13 are established based on prior adjustment of the designated attributes of the modulation signal 13 according to steps 52, 54 (step 56).

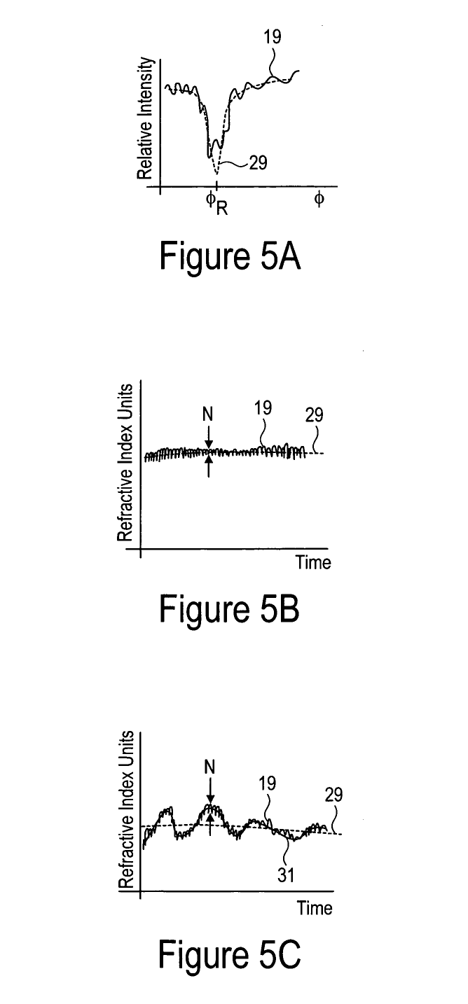

An example of the method 50 is provided in the context of SPR measurements that are acquired by the measurement system 10. In an unmodulated state of the modulated laser source 12, the detected signal 19 provided by the measurement system 10 has a time-varying ripple on the detected signal 19, in addition to a desired signal component 29 of the detected signal 19. FIG. 5A shows one example of the detected signal 19 that is processed to provide a plot of relative intensity versus incidence angle Φ of the optical signal 15 on the target 14, which includes a resonant incidence angle Φ_{R}. The desired signal component 29 is indicated by a dashed contour within the detected signal 19 that also includes the time-varying ripple. In SPR measurements, shifts in the resonant incidence angle Φ_{R} are used to detect shifts in refractive indices of the SPR sensor included in the target 14. The time-varying ripple on the detected signal 19 can mask or otherwise obscure the desired signal component 29 of the detected signal 19 that is used to detect shifts in resonant incidence angle Φ_{R} associated with the target 14. In the modulated state of the modulated laser source 12, the magnitude of the time-varying ripple on the detected signal 19 is substantially reduced, so that the detected signal 19 becomes approximately equal to the desired signal component 29.

In an SPR measurement, the time-varying ripple shown in FIG. 5A results in a drift component 31 (shown in FIG. 5C) when the detected signal 19 is processed to indicate refractive index units versus time. The resulting drift component 31 can mask or otherwise obscure the desired signal component 29 of the detected signal 19 that is used to detect shifts in refractive index of the target 14. The drift component 31 of the detected signal 19 is typically attributed to interference effects due to optical reflections within or between input optical elements 18 or output optical elements 20, including lenses, polarizers, acousto-optic deflectors, telescopes, filters, or other devices, elements, or systems within the optical signal paths of the measurement system 10. The time-varying aspect of the ripple, which results in the drift component 31 of the detected signal 19 is typically due to thermal effects.

FIGS. 5B-5C show examples of detected signals 19 that are processed to provide a plot of refractive index units versus time, for a target 14 configured for calibration of an SPR measurement. In FIG. 5B, the modulated laser source 12 is in a modulated state, wherein the detected signal 19 includes a signal component 29 that is a constant signal with the inherent noise N of the measurement system 10 present on the signal component 29. In FIG. 5C, the modulated laser source 12 is in an unmodulated state, wherein the detected signal 19 includes a constant signal component 29 with an undesired drift component 31 superimposed on the desired signal component 29, in addition to the inherent noise N of the measurement system 10 that is also present on the detected signal 19. The drift component 31 of the detected signal 19 has lower magnitude in the modulated state (shown in FIG. 5B) of the modulated laser source 12 than in the unmodulated state (shown in FIG. 5C). Because the drift component 31 shown in FIG. 5C is insignificant in FIG. 5B, the drift component 31 is not indicated in FIG. 5B.

The reduction of coherence length provided in the modulated state of the modulated laser source 12 can substantially reduce, or even eliminate the drift component 31 that is attributable to interference effects of the measurement system 10. Step 52 of the method 50 can be applied to the measurement system 10 by adjusting the attributes of the modulation signal 13, such as the amplitude, waveform shape, or frequency while observing the detected signal 19 provided by the measurement system (step 54). By applying step 56 of the method 50, steps 52 and 54 can be repeated until the drift component 31 of the detected signal 19 is minimized or is satisfactorily small. Based on application of the method 50 to the measurement system 10, the attributes of the modulation signal 13 can be selected so that the modulated state of the modulated laser source 12 provides a reduction in the drift component 31 of the detected signal 19 that is sufficient to enable the signal component 29 of the detected signal 19 to adequately detect shifts in refractive indices of the target 14.

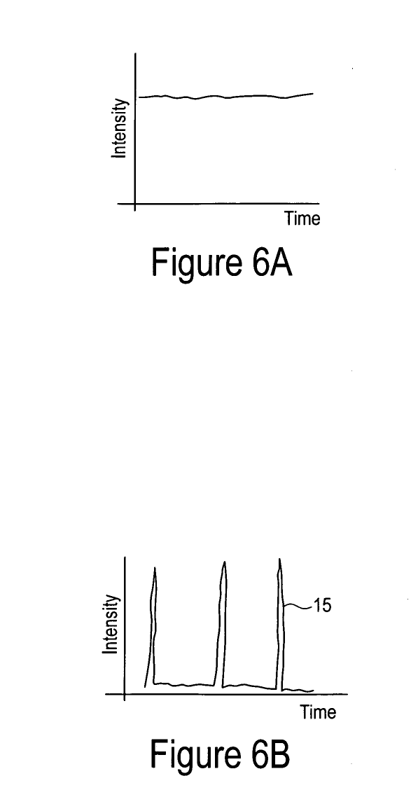

According to alternative embodiments of the present invention, the attributes of the modulation signal 13 are established based on the optical signal 15 that results at the output of the modulated laser source 12 in the modulated state. In one example, the amplitude and/or frequency of the modulation signal 13 applied to the modulated laser source 12 are varied until the optical signal 15 shifts from a continuous wave (CW) mode of operation (shown in an example in FIG. 6A) to a pulsed mode of operation, providing a pulsed signal (shown in an example in FIG. 6B). In the pulsed mode of operation, phase continuity, or coherence, between pulses in the pulsed signal is significantly reduced.

While examples of alternative methods of establishing the attributes of the modulation signal 13 have been provided for the purpose of illustration, alternative embodiments of the present invention include modulation signals 13 that have attributes established according to any suitable method. The modulation signal 13 provides for amplitude and/or frequency modulation of the modulated laser source 12. The modulation signal 13 can also provide intensity modulation of the modulated laser source 12 due to the inherent relationship between amplitude and intensity of an optical signal 15.

The detector 16 included in the measurement system 10 intercepts the deflected signal 11 that is provided by the target 14, and provides a detected signal 19 in response to the intercepted signal 11. The detector 16 typically includes a silicon, germanium, or indium-gallium-arsenide photodiode, a camera module, or a photomultiplier tube. The detector 16 can also include any device, element, or array of devices or elements that provide one or more detected signals 19 in response to the deflected signal 11. The detector 16 typically includes a processor (not shown) that receives the detected signal 19 and processes the detected signal 19 to provide an output to a display or other output device. The processor enables the detected signal 19 to indicate relative intensity versus incidence angle Φ as shown in FIG. 5A, or to indicate refractive index units versus time as shown in FIGS. 5B-5C. Suitable processors are well-known in the art and are typically included in conventional SPR measurement systems.

The type of target 14 that is included in the measurement system 10 depends on the type of the measurement system 10. For example, in the measurement system 10 shown in FIG. 1, the target 14 includes an SPR sensor. The target 14 can also include a RiFS sensor, a CPWR sensor or any other target 14 suitable for providing a deflected signal 11 in response to illumination by optical signal 15 provided by the modulated optical source 12.

While the embodiments of the present invention have been illustrated in detail, it should be apparent that modifications and adaptations to these embodiments may occur to one skilled in the art without departing from the scope of the present invention as set forth in the following claims.

1. A system, comprising:
a modulated laser source illuminating a target within a measurement system, the laser source having a first coherence length in an unmodulated state and a second coherence length in a modulated state; and
a detector receiving a deflected signal from the target and providing a detected signal having a signal component and a drift component, wherein the drift component has a lower magnitude in the modulated state than in the unmodulated state of the laser source.

2. The system of claim 1 wherein the measurement system includes an SPR measurement system and wherein the target is an SPR sensor.

3. The system of claim 1 wherein the measurement system includes a RiFS measurement system and wherein the target is a RiFS sensor.

4. The system of claim 1 wherein the measurement system includes a CPWR measurement system and wherein the target is a CPWR sensor.

5. The system of claim 1 wherein the modulated laser source includes a diode laser having at least of a first coherence length greater than two centimeters and a second coherence length less than two centimeters.

6. The system of claim 1 wherein the modulated laser source includes one of a laser diode, a solid-state laser, a gas laser, a semiconductor laser with an external cavity, a mode-locked laser, frequency-chirped laser, and a gain-switched laser.

7. The system of claim 2 wherein the modulated laser source includes one of a laser diode, a solid-state laser, a gas laser, a semiconductor laser with an external cavity, a mode-locked laser, frequency-chirped laser, and a gain-switched laser.

8. The system of claim 2 wherein the modulated laser source includes a laser diode and the modulated state is achieved via a modulation signal superimposed on a drive signal, provided to the laser diode through a bias tee.

9. The system of claim 8 wherein attributes of the modulation signal are established by adjusting at least one of the amplitude and the frequency of the modulation signal, observing the detected signal, and either readjusting at least one of the amplitude and the frequency of the modulation signal or establishing the attributes of the modulation signal from a prior adjustment of the at least one of the amplitude and the frequency of the modulation signal, based on characteristics of the observed detected signal.

10. The system of claim 9 wherein the modulated laser source provides an optical signal to the target that is a pulsed optical signal.

11. A system, comprising:
a modulated laser source illuminating a target within a measurement system, the laser source having a first coherence length in an unmodulated state and a second coherence length in a modulated state that is shorter than the first coherence length, wherein the modulated state is provided by a modulation signal applied to the modulated laser source; and
a detector receiving a deflected signal from the target and providing a detected signal having a signal component and a drift component, wherein the drift component has a lower magnitude in the modulated state than in the unmodulated state of the modulated laser source.

12. The system of claim 11 wherein the measurement system includes an SPR measurement system and wherein the target is an SPR sensor.

13. The system of claim 11 wherein the modulated laser source includes a laser diode and the modulation signal includes a modulation current superimposed on a drive current.

14. The system of claim 13 wherein the modulated laser source includes a bias and wherein the modulation signal is applied to the laser diode through a bias tee.

15. The system of claim 11 wherein the modulation signal has attributes that are established by adjusting at least one of the amplitude and the frequency of the modulation signal, observing the detected signal, and either readjusting at least one of the amplitude and the frequency of the modulation signal or establishing the attributes of the modulation signal from prior adjustment of the at least one of the amplitude and the frequency of the modulation signal, based on characteristics of the observed detected signal.

16. A system, comprising:
a modulated laser source illuminating a target within a measurement system, the laser source having a first coherence length in an unmodulated state and a second coherence length in a modulated state; and
a detector receiving a deflected signal from the target and providing a detected signal having a signal component and a time-varying ripple, wherein the time-varying ripple has a lower magnitude in the modulated state than in the unmodulated state of the modulated laser source.

17. The system of claim 16 wherein the measurement system includes an SPR measurement system and wherein the target is an SPR sensor.

18. The system of claim 16 wherein the modulated laser source includes a laser diode and wherein the modulated state is provided by an applied modulation signal that includes a modulation current superimposed on a drive current.

19. The system of claim 18 wherein the modulated laser source includes a bias and wherein the modulation signal is applied to the laser diode through a bias tee.

20. The system of claim 16 wherein the modulation signal has attributes that are established by adjusting at least one of the amplitude and the frequency of the modulation signal, observing the detected signal, and either readjusting at least one of the amplitude and the frequency of the modulation signal or establishing the attributes of the modulation signal from prior adjustment of the at least one of the amplitude and the frequency of the modulation signal, based on characteristics of the observed detected signal.
